(19) United States
(12) Patent Application Publication
(10) Pub. No.: US 2022/0219556 A1
(43) Pub. Date: Jul. 14, 2022

(54) Charging System for DC Charging of the Traction Battery of an Electrically Powered Motor Vehicle

(71) Applicant: KOSTAL Automobil Elektrik GmbH & Co. KG, Luedenscheid (DE)

(72) Inventors: Christian Hirschauer, Schwelm (DE); Sven Wessel, Wuppertal (DE)

(73) Assignee: KOSTAL Automobil Elektrik GmbH & Co. KG, Luedenscheid (DE)

(21) Appl. No.: 17/670,563

(22) Filed: Feb. 14, 2022

Related U.S. Application Data
(63) Continuation of application No. PCT/EP2020/073856, filed on Aug. 26, 2020.

(30) Foreign Application Priority Data
Aug. 28, 2019 (DE) 10 2019 006 065.2

(51) Int. Cl. B60L 53/35; H02J 7/00; H02J 7/02; B60L 53/22; B60L 53/18; B60L 53/16

(52) U.S. Cl. CPC B60L 53/35; H02J 7/0042; H02J 7/02; B60L 53/22; B60L 2210/30; B60L 53/16; H02J 2207/20; H02J 2310/48; B60L 53/18

(57) ABSTRACT

A charging system for direct current (DC) charging of a traction battery of an electric vehicle includes a stationary charging station and a portable module. The stationary charging station is connectable to a three-phase alternating current (AC) power supply operable for supplying first, second, and third phases of AC current. The stationary charging station has second and third AC/DC converters for the second and third phases of AC current, respectively. The portable module is removably connectable to the stationary charging station. The portable module has a first AC/DC converter for the first phase of AC current.

### CROSS-REFERENCE TO RELATED APPLICATIONS

This application is a continuation of International Application No. PCT/EP2020/073856, published in German, with an international filing date of Aug. 26, 2020, which claims priority to DE 10 2019 006 065.2, filed Aug. 28, 2019, the disclosures of which are hereby incorporated in their entirety by reference herein.

### TECHNICAL FIELD

The present invention relates to a charging system for direct current (DC) charging of the traction battery of an electrically powered motor vehicle, the charging system including a stationary charging station that is connected to a three-phase alternating current (AC) power supply, and the charging system further including AC/DC converters for each of the three phases.

### BACKGROUND

The terms “electric vehicle” and “electrically powered motor vehicle” are understood here to mean a vehicle that is powered either exclusively or additionally by an electric motor using electrical energy from a traction battery, and that at least optionally provides an electrical charging option at an external power source for charging the traction battery. In particular, so-called plug-in hybrid vehicles are included here as electric vehicles.

Alternating current (AC) charging on the one hand and direct current (DC) charging on the other hand have become established as possible charging modes for the conductive (i.e., wired) charging of electric vehicles. In AC charging, a single-phase or multi-phase AC current is supplied to the electric vehicle via a connection line. An AC/DC converter assembly present in a charging device on the vehicle-side (e.g., an on-board charger) generates a DC current from this supply AC current. In turn, the vehicle-side charging device charges the traction battery with the DC current. Fully charging a discharged traction battery in this manner can take several hours.

In DC charging, the electric vehicle is supplied with a DC current at a charging station. The traction battery may be directly connected to the charging station to receive the DC current. In this case, generally, the traction battery is directly connected to the charging station via a mechanical or electronic isolating switch, but without using vehicle-side converter circuits. Such vehicle-side converter circuits are subject to strict installation space and weight restrictions. During the DC charging, it is thus possible to provide much higher currents than with AC current charging. Consequently, the charging operation may take place comparatively quickly. This is due to the fact that the charging station, such as in the form of a charging column or a wall-box, may have a design that is much larger than the vehicle-side charging device.

Dispensing with the vehicle-side converter circuits on electric vehicles, as components of so-called onboard chargers, also offers considerable cost advantages. However, these electric vehicles are then provided only with a DC charging option and thus rely on appropriate DC charging stations. In the event that the electric vehicle is far away from a suitable DC charging infrastructure, there is a need for a portable charging option via which charging the vehicle at public AC charging stations and at household AC electrical outlets is possible.

### SUMMARY

A charging system for direct current (DC) charging of a traction battery of an electric vehicle includes a stationary charging station and a portable module. The portable module is removably connectable to the stationary charging station. The stationary charging station is connected to a three-phase alternating current (AC) power supply. The portable module includes a first AC/DC converter for the first phase of the AC power supply. The stationary charging station includes second and third AC/DC converters for the second and third phases of the AC power supply, respectively. The portable module includes a housing which is removably separable from the stationary charging station for the portable module to be removably connectable to the stationary charging station. Further electronic components supplementing the first AC/DC converter are provided within the housing of the portable module to make the portable module be functional as an autonomous, single-phase charger.

Embodiments of the present invention develop a charging system described above at the outset for DC charging of the traction battery of an electric vehicle in such a way that it is now possible to charge the traction battery even when a suitable stationary DC charging station cannot be reached by the electric vehicle. For example, the electric vehicle cannot reach a suitable stationary DC charging station due to the remaining charge of the traction battery being excessively low. With the use of the charging system in accordance with embodiments of the present invention, the charging operation may be carried out at practically any ordinary access point to a power grid connection.

A charging system in accordance with embodiments of the present invention achieves such features by an AC/DC converter for one of the three phases of AC current being designed as part of a portable module that can be removed from a stationary charging station. The AC/DC converter of the portable module converts the one phase of AC current into a DC current. The portable module is provided with a housing that is separable from the stationary charging station and in which further electronic components are provided. These further electronic components supplement the portable module to form an independent, single-phase charging device.

The stationary charging station includes two other AC/DC converters for the two other phases of AC current, respectively. The two AC/DC converters of the stationary charging station convert the two other phases of AC current into two other DC currents, respectively.

The stationary charging station combines the DC current that is generated in the portable module from the one phase of AC current with the two DC currents that are generated in the stationary charging station from the other two phases of AC current. The stationary charging station makes available the DC current generated from all three phases of AC current at a DC charging cable of the stationary charging station. The DC charging cable connects to the electric vehicle to transfer the DC current generated from all three phases of AC current to the traction battery of the electric vehicle. By providing that the DC current generated in the portable module from the one phase of AC current is combined with the two DC currents generated in the stationary charging station from the other two phases of AC current, the components for filtering, rectification, power factor correction, galvanic isolation, and current regulation in the stationary charging station for the one phase of AC current may be omitted.

The portable module itself, with its integrated AC/DC converter that is independent from the stationary charging station, represents a self-contained, independent DC charging device that may be connected on the input side to any single-phase AC power supply.

### BRIEF DESCRIPTION OF THE DRAWINGS

Advantageous embodiments of the subject matter according to the present invention are set forth and explained in greater detail based on one exemplary embodiment of a charging system illustrated in the drawings in which:

FIG. 1 illustrates the charging system as a so-called wall-box, the charging system including a stationary charging station and a portable module that is removably connectable to the stationary charging station, a top portion of FIG. 1 depicting the portable module being connected to the stationary charging station and a bottom portion of FIG. 1 depicting the portable module being disconnected from the stationary charging station; and

FIG. 2 illustrates a schematic illustration of the electrical components of the charging system.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

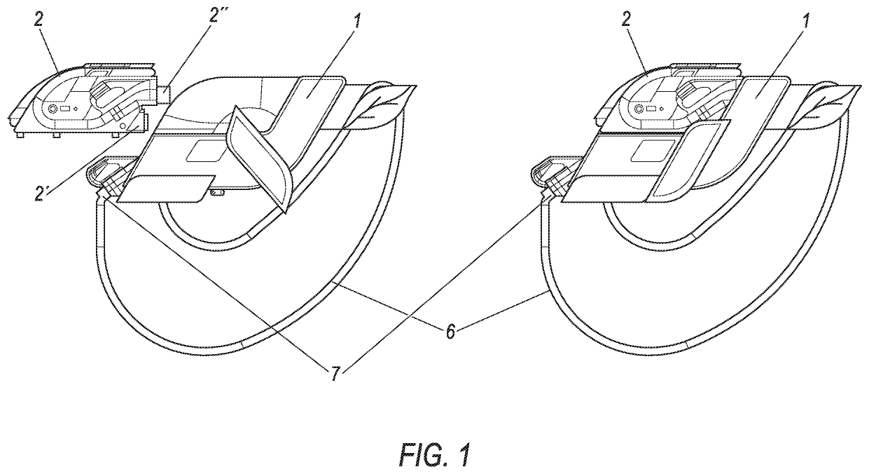

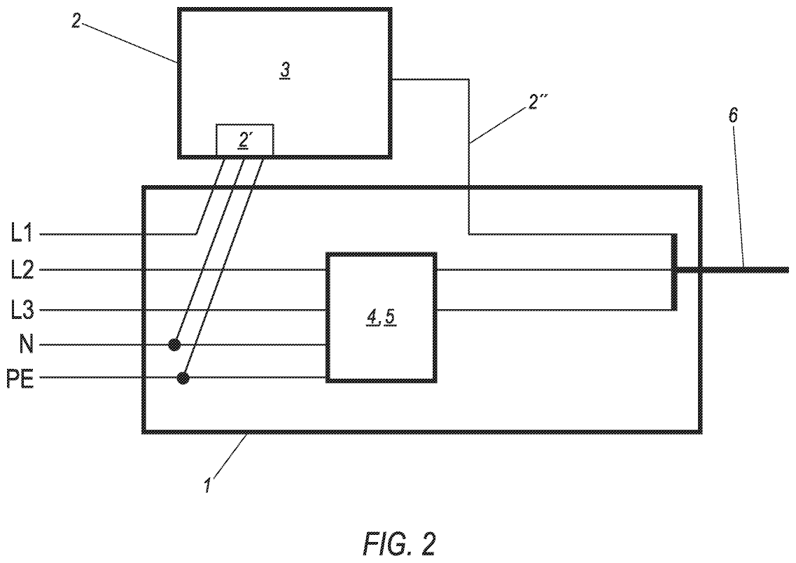

Referring now to FIGS. 1 and 2, a charging system in accordance with an exemplary embodiment of the present invention is shown. The charging system includes a stationary charging station 1 and a portable module 2.

Stationary charging station 1 includes a docking station with a stable housing. The stable housing of the docking station of stationary charging station 1 is fastened to a wall, for instance. The docking station of stationary charging station 1 has a long cable 6 with an appropriate plug 7 for DC charging of an electric vehicle, and an operating option.

Portable module 2 is removably connectable to stationary charging station 1. In this regard, a top portion of FIG. 1 depicts portable module 2 connected to stationary charging station 1 and a bottom portion of FIG. 1 depicts portable module 2 disconnected from stationary charging station 1. When disconnected from stationary charging station 1, portable module 2 can be moved remotely away from stationary charging station 1.

Portable module includes a first AC/DC converter 3. Stationary charging station 1 includes second and third AC/DC converters 4 and 5 within its docking station.

Stationary charging station 1 is permanently linked electrically to a three-phase alternating current (AC) power supply. AC current from the three-phase AC current supply is composed of first, second, third phases of AC current. The connection of stationary charging station 1 to the three-phase AC power supply is made up of three phases L1, L2, L3, a neutral conductor N, and a protective ground PE. First, second, and third phases L1, L2, L3 are divided within stationary charging station 1, as shown in FIG. 2.

The second and third phases of AC current from the three-phase AC power supply, which respectively correspond to the second and third phases L2 and L3, are respectively converted into second and third DC currents by the second and third AC/DC converters 4 and 5 of stationary charging station 1.

While portable module 2 is connected to (e.g., latched into) stationary charging station 1, the first phase of AC current from the three-phase AC power supply, which corresponds to first phase L1, conducts to a plug that engages with an AC input receptacle of portable module 2 via an interface 2′ of the portable module. Portable module 2 is thus connected to a single-phase AC current supply L1, N, and PE. On the portable module side, the first phase of AC current is converted into a first DC current by first AC/DC converter 3 of portable module 2. The first DC current is conducted from portable module 2 back into stationary charging station 1 via a separable connection 2″ and a DC output plug of the portable module.

Stationary charging station 1 combines the first DC current that is generated by portable module 2 from the first phase L1 with the second and third DC currents that are generated internally by the stationary charging station from the second and third phases L2 and L3. Stationary charging station 1 outputs the combined DC current generated from all three phases at DC charging cable 6 (depicted by a thick line) of the docking station of the stationary charging station. When the electric vehicle is connected to DC charging cable 6, the traction battery of the electric vehicle is charged with this combined DC current.

While portable module 2 is disconnected from stationary charging station 1, the portable module with its integrated AC/DC converter 3 represents a self-contained DC charging device that is independent from the stationary charging station. As a self-contained DC charging device, portable module 2 may be carried in the electric vehicle and driven away from stationary charging station 1 as desired. Further, as a self-contained DC charging device, portable module 2 may be connected on the input side to any single-phase AC power supply, whether at public AC charging stations or at household AC electrical outlets.

In use, first AC/DC converter 3 of portable module 2 converts the single-phase AC current from the single-phase AC power supply to DC current and portable module 2 outputs this DC current at separable connection 2″ and the DC output plug of the portable module. During this process, while the electric vehicle is connected to the DC output plug of portable module 2, the traction battery of the electric vehicle is charged with the DC current outputted from portable module 2.

There is also the option of providing a permanent plug-in socket for portable module 2 in the electric vehicle, for example, in the trunk of the electric vehicle. In this case, portable module 2 on the one hand may be safely transported and on the other hand is already permanently electrically connected between an AC input of the electric vehicle and a DC input. As such, for charging the traction battery, the connection to the AC input side of the electric vehicle only has to be made from the outside for charging.

The charging system in accordance with embodiments of the present invention allows a user of an electric vehicle to decide, depending on how the vehicle is used, whether to carry portable module 2 in the vehicle to allow charging of the traction battery regardless of the availability of a suitable stationary DC charging station, or, when only short distances are being traveled by the vehicle, to omit the portable module and benefit from the increased charging power of the combined wall-box in order to save on additional weight and to increase the available cargo space.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A charging system for direct current (DC) charging of a traction battery of an electric vehicle, the charging system comprising:
a stationary charging station connectable to a three-phase alternating current (AC) power supply operable for supplying first, second, and third phases of AC current, the stationary charging station having second and third AC/DC converters for the second and third phases of AC current, respectively; and
a portable module removably connectable to the stationary charging station, the portable module having a first AC/DC converter for the first phase of AC current.

2. The charging system of claim 1 wherein:
the stationary charging station is connected to the three-phase AC power supply; and
the second and third AC/DC converters of the stationary charging system convert the second and third phases of AC current into second and third DC currents, respectively.

3. The charging system of claim 2 wherein:
the portable module is connected to the stationary charging station;
the first AC/DC converter of the portable module converts the first phase of AC current into a first DC current and outputs the first DC current to the stationary charging system via a DC output plug of the portable module; and
the stationary charging station combines the first DC current and the second and third DC currents into a combined DC current and outputs the combined DC current onto a DC charging cable of the stationary charging station whereby the traction battery of the electric vehicle is charged with the combined DC current while the electric vehicle is connected to the DC charging cable.

4. The charging system of claim 1 wherein:
the portable module is disconnected from the stationary charging station and is connected to a different AC power supply operable for supplying a phase of AC current; and
the first AC/DC converter of the portable module converts the phase of AC current supplied from the different AC power supply into a DC current and outputs the DC current onto a DC output plug of the portable module whereby the traction battery of the electric vehicle is charged with the DC current while the electric vehicle is connected to the DC output plug.

5. The charging system of claim 4 wherein:
the different AC power supply is a single-phase AC power supply.

6. The charging system of claim 1 wherein:
the portable module includes a receptacle and a DC output plug; and
the portable module is connected to the stationary charging system while a plug of the stationary charging station is plugged into the receptacle of the portable module and the DC output plug of the portable module is plugged into the stationary charging station.

7. The charging system of claim 1 wherein:
the portable module includes a housing in which the first AC/DC converter of the portable module is contained; and
the housing of the portable module is remotely located from the stationary charging system while the portable module is connected to the stationary charging system.

8. The charging system of claim 1 wherein:
the portable module is disconnected from the stationary charging station and is connected between an AC input of the electric vehicle and the traction battery of the electric vehicle.

9. The charging system of claim 8 wherein:
while the AC input of the electric vehicle is connected to a different AC power supply operable for supplying a phase of AC current, the first AC/DC converter of the portable module converts the phase of AC current supplied, via the AC input of the electric vehicle, from the different AC power supply into a DC current and outputs the DC current to the traction battery for charging the traction battery.

10. A charging system for direct current (DC) charging of a traction battery of an electric vehicle, the charging system comprising:
a stationary charging station connected to a three-phase alternating current (AC) power supply operable for supplying first, second, and third phases of AC current, the stationary charging station having second and third AC/DC converters which convert the second and third phases of AC current into second and third DC currents, respectively;
a portable module removably connectable to the stationary charging station, the portable module having a first AC/DC converter; and
wherein, while the portable module is connected to the stationary charging station, the first AC/DC converter of the portable module converts the first phase of AC current into a first DC current and outputs the first DC current to the stationary charging system and the stationary charging system combines the first DC current and the second and third DC currents into a combined DC current and outputs the combined DC current onto a DC charging cable of the stationary charging station whereby the traction battery of the electric vehicle is charged with the combined DC current while the electric vehicle is connected to the DC charging cable.

11. The charging system of claim 10 wherein:
while the portable module is disconnected from the stationary charging station and is connected to a different AC power supply operable for supplying a phase of AC current, the first AC/DC converter of the portable module converts the phase of AC current of the different AC power supply into a fourth DC current and outputs the fourth DC current onto a DC output plug of the portable module whereby the traction battery of the electric vehicle is charged with the fourth DC current while the electric vehicle is connected to the DC output plug.

12. The charging system of claim 10 wherein:
the portable module includes a receptacle and a DC output plug; and
the portable module is connected to the stationary charging system while a plug of the stationary charging station is plugged into the receptacle of the portable module and the DC output plug of the portable module is plugged into the stationary charging station.

13. The charging system of claim 10 wherein:
the portable module includes a housing in which the first AC/DC converter of the portable module is contained; and
the housing of the portable module is remotely located from the stationary charging system while the portable module is connected to the stationary charging system.

14. The charging system of claim 10 wherein:
the portable module is disconnected from the stationary charging station and is connected between an AC input of the electric vehicle and the traction battery of the electric vehicle.

15. The charging system of claim 14 wherein:
while the AC input of the electric vehicle is connected to a different AC power supply operable for supplying a phase of AC current, the first AC/DC converter of the portable module converts the phase of AC current supplied, via the AC input of the electric vehicle, from the different AC power supply into a DC current and outputs the DC current to the traction battery for charging the traction battery.
